(19) United States
(12) Patent Application Publication
(10) Pub. No.: US 2014/0074912 A1
(43) Pub. Date: Mar. 13, 2014

(54) COMMUNICATION APPARATUS, RELAY APPARATUS AND COMMUNICATION METHOD

(71) Applicant: KABUSHIKI KAISHA TOSHIBA, Tokyo (JP)

(72) Inventors: Hiroshi NISHIMOTO, Kawasaki-Shi (JP); Yuichiro OYAMA, Tokyo (JP); Takeshi ISHIHARA, Yokohama-Shi (JP)

(73) Assignee: KABUSHIKI KAISHA TOSHIBA, Tokyo (JP)

(21) Appl. No.: 14/020,101

(22) Filed: Sep. 6, 2013

(30) Foreign Application Priority Data
Sep. 11, 2012 (JP) 2012-199581

(51) Int. Cl. H04L 29/06

(52) U.S. Cl. CPC H04L 29/06047
USPC 709/203

(57) ABSTRACT

A communication apparatus has a communication part configured to communicate with a different communication apparatus, an information request part configured to generate information requests to the different communication apparatus, an information acquisition request generating part configured to generate information acquisition requests each comprising meta-information added to each of the information requests generated by the information request part, and an information request processing part configured to generate a pipeline request in which as many of the information acquisition requests as possible are concatenated within a length which does not exceed an information delimiter prescribed by a low-level protocol of a level lower than a protocol used to transmit the pipeline request to the different communication apparatus via the communication part.

### CROSS REFERENCE TO RELATED APPLICATIONS

This application is based upon and claims the benefit of priority from the prior Japanese Patent Application No. 2012-199581, filed on Sep. 11, 2012, the entire contents of which are incorporated herein by reference.

### FIELD

Embodiments of the present invention relate to a communication apparatus, a relay apparatus and a communication method that make a request for information to another communication apparatus.

### BACKGROUND

TCP uses a congestion avoidance algorism referred to as “slow-start” that enlarges a TCP window while data transmission and reception are repeated between a client and a server. Therefore, whenever file acquisition is started by using TCP/IP, it is affected by slow-start. For example, even in a network of wide bandwidth that allows high-speed communication, when a reciprocal delay time is long, throughput becomes low at the start of communication. Therefore, it takes much time to raise throughput. In the Internet, a client and a server are mostly located physically apart from each other, so it is difficult to shorten a data load time.

One technique of reducing a problem of the data load time is HTTP pipelining. HTTP/1.1 supports persistent connection that makes possible to make a plurality of HTTP requests and replies using a single TCP connection. HTTP pipelining has made it possible to transmit requests to a server in succession without waiting for responses from the server. With this technique, the number of times of sending and receiving requests and responses has been reduced.

However, actually, even if a plurality HTTP requests are transmitted to a server using a single TCP connection, due to the effects of TCP slow-start, throughput becomes low at the start of communication if a reciprocal delay time is long. Therefore, the problem that it takes much time to raise throughput cannot be solved.

In recent browsers, data can be acquired at high speed by establishing many connections simultaneously. The technique of establishing many connections simultaneously reduces the problem of reciprocal delay time. However, this technique consumes resources such as memory and CPU usages in both of a client and a server.

When a client transmits requests by HTTP pipelining, even if the data length after request coupling is within a data length that can be correctly handled by HTTP, if the data length after request coupling is longer than a packet length of IP packets, an HTTP request extends over a plurality of packets. When a server receives a header packet, the server creates a new instance to start processing, but cannot release resources until succeeding packets reach. Therefore, when a pipeline request from a client extends over a plurality of packets, a sever cannot release resources until the last request reaches. This results in that the server consumes a large amount of resources and it takes much time to generate responses.

When a client makes a request with a single packet, if a server can prepare response data quickly, the server can transmit TCP ACK with the response data. However, when a client makes a request over a plurality of packets, a server transmits TCP ACK to a client separated from response data. Therefore, the client's NIC receiving time increases, and hence power consumption increases.

Therefore, when a client transmits a request to a server, it is important that the request does not extend over a plurality of packets.

Moreover, concerning data to be transmitted from a server to a client, it is desirable to reduce the number of responses as much as possible by using a pipeline.

### BRIEF DESCRIPTION OF THE DRAWINGS

FIG. 1 is a block diagram schematically showing the configuration of an information processing system 1 according to a first embodiment;

FIG. 2 is a sequence diagram showing an example of an operation of a client 2 according to the first embodiment;

FIG. 3 is a flowchart showing an example of a procedure of an information request processing part 7 according to the first embodiment;

FIG. 4 is a view showing an example of packing information acquisition requests;

FIG. 5 is a block diagram schematically showing the configuration of an information processing system 1 according to a second embodiment;

FIG. 6 is a sequence diagram showing an example of a procedure of a client 2 according to the second embodiment;

FIG. 7 is a flowchart showing an example of a procedure of an information request processing part 7 according to the second embodiment;

FIG. 8 is a view schematically showing an example of a technique of generating pipeline requests according to the second embodiment;

FIG. 9 is a flowchart showing a procedure of an information request processing part 7 according to a third embodiment;

FIG. 10 is a block diagram schematically showing the configuration of an information processing system 1 provided with a server 3 according to a fourth embodiment;

FIG. 11 is a flowchart showing an example of a procedure of an information response processing part 25 of FIG. 10; and

FIG. 12 is a block diagram schematically showing the configuration of an information processing system 1 according to a fifth embodiment.

### DETAILED DESCRIPTION

According to a communication apparatus has a communication part configured to communicate with a different communication apparatus, an information request part configured to generate information apparatus requests to the different communication apparatus, an information acquisition request generating part configured to generate information acquisition requests each comprising meta-information added to each of the information requests generated by the information request part, and an information request processing part configured to generate a pipeline request in which as many of the information acquisition requests as possible are concatenated within a length which does not exceed an information delimiter prescribed by a low-level protocol of a level lower than a protocol used to transmit the pipeline request to the different communication apparatus via the communication part.

Embodiments will now be explained with reference to the accompanying drawings.

### First Embodiment

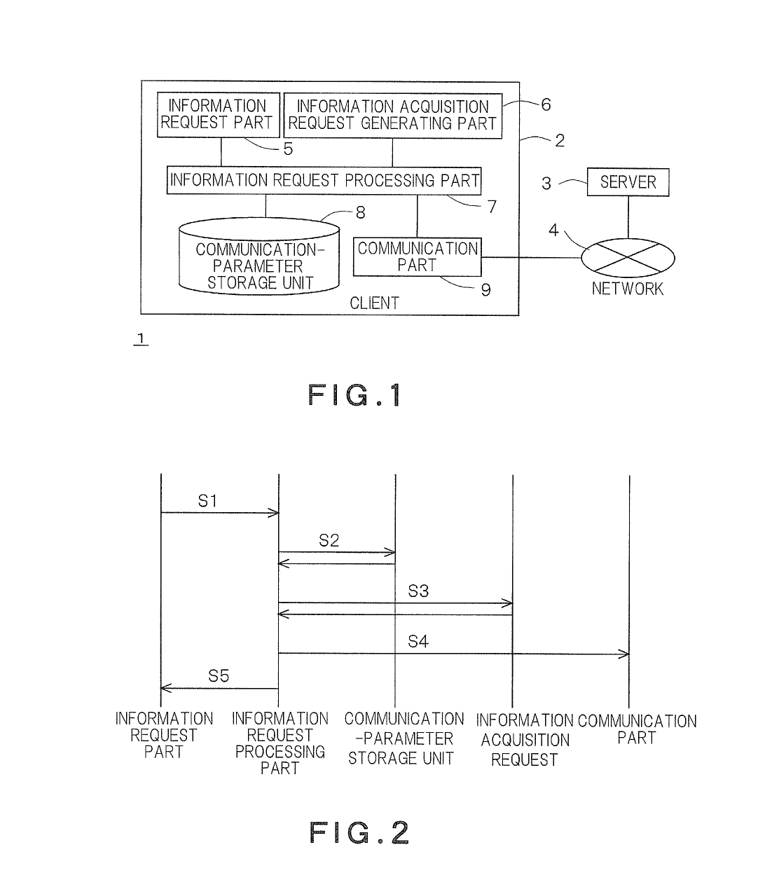

FIG. 1 is a block diagram schematically showing the configuration of an information processing system 1 according to a first embodiment. The information processing system 1 of FIG. 1 is provided with a client 2 and a server 3. The client 2 and the server 3 communicate with each other via a network 4. The specific configuration of the network 4 is not limited to any particular one. The network 4 may, for example, be a public network such as the Internet or an exclusive-use network. Moreover, the network 4 may be wired such as the Ethernet (a registered trademark) or wireless such as wireless LAN. The type of protocol used for communication between the client 2 and the server 3 via the network 4 is also not limited to any particular one.

The client 2 has an information request part 5, an information acquisition request generating part 6, an information request processing part 7, a communication-parameter storage unit 8, and a communication part 9.

The information request part 5 generates a request for some kind of information to the server 3 in response to some kind of input as a trigger. Input as a trigger may, for example, be user input, periodic input based on measurement by a timer, etc.

The information acquisition request generating part 6 adds meta-information to the information requests generated by the information request part 5 to generate information acquisition requests. The meta-information is header information, written in which is a file type of information or the like. The information acquisition requests generated by the information acquisition request generating part 6 are transmitted to the information request processing part 7.

The information request processing part 7 performs a process of transmitting the information acquisition requests generated by the information acquisition request generating part 6 to the server 3 via the communication part 9 by using a plurality of connections. In more detail, the information request processing part 7 allocates the information acquisition requests generated by the information acquisition request generating part 6 to a plurality of connections to generate pipeline requests, in each of which as many of the information acquisition requests as possible are concatenated. The protocol to be used is not limited to any particular one as long as it ensures data reachability. For example, HTTP, HTTPS and TCP/IP can be used. When generating a pipeline request, the information request processing part 7 generates a pipeline request in which as many information acquisition requests as possible concatenated one another within a range that does not exceed PDU (Protocol Data Unit) that is an information delimiter prescribed by a low-level protocol of a level lower than a protocol used to transmit information acquisition requests. Then, the information request processing part 7 transfers pipeline requests to the communication part 9. The communication part 9 transmits the pipeline requests generated by the information request processing part 7 to the server 3.

The communication-parameter storage unit 8 stores a variety of communication parameters concerning a communication protocol to be used when information acquisition requests are transmitted to the server 3. Representatives of the communication parameter are throughput, a delay time, the degree of change of these factors, a TCP congestion window per TCP connection, MSS (Maximum Segment Size), a maximum TCP packet size, IP MTU (Maximum Transmission Unit), a frame length in the physical layer, etc.

As described above, the information request processing part 7 generates pipeline requests, in each of which as many information acquisition requests as possible are concatenated so that information is not fragmented in a communication path between the cline 2 and the server 3. For example, the information request processing part 7 generates a pipeline request in which as many information acquisition requests as possible are concatenated within a congestion window size.

FIG. 2 is a sequence diagram showing an example of an operation of the client 2 according to the first embodiment. Information requests generated by the information request part 5 are transferred to the information acquisition request generating part 6 via the information request processing part 7 (step S1).

The information request processing part 7 acquires communication parameters concerning a protocol to be used for transmitting information acquisition requests to the server 3 from the communication-parameter storage unit 8 (step S2).

The information acquisition request generating part 6 adds meta-information to the information requests generated by the information request part 5 to generate information acquisition requests (step S3).

The information request processing part 7 allocates the information acquisition requests generated by the information acquisition request generating part 6 to a plurality of connections to generate pipeline requests for respective connections and transfers the pipeline requests to the communication part 9 (step S4). Moreover, the information request processing part 7 notifies the information request part 5 that the transfer of information acquisition requests has completed (step S5).

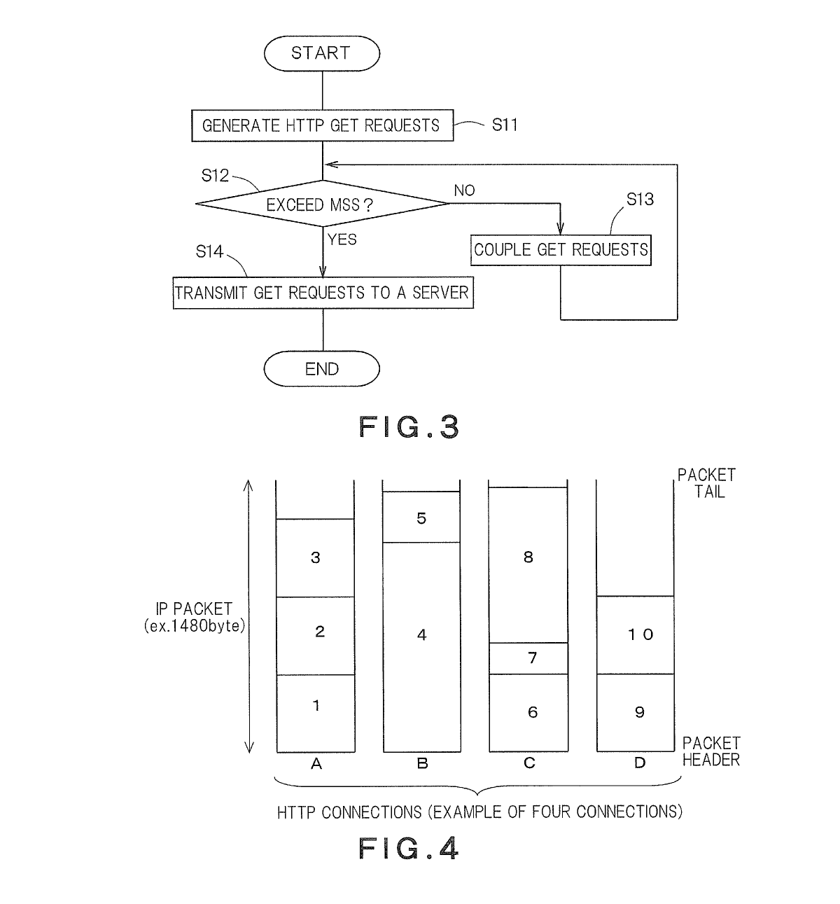

FIG. 3 is a flowchart showing an example of a procedure of the information request processing part 7 according to the first embodiment. Firstly, an HTTP GET request is generated (step S11). Then, it is determined whether the GET request exceeds the MSS size of TCP that is a low-level protocol of HTTP (step S12). If the GET request does not exceed the MSS size of TCP, the next GET request is coupled to the generated GET request to generate a pipeline request (step S13) and the procedure returns to step S12.

If it is determined in step S12 that the GET request has exceeded the MSS size of TCP, the generated GET request is transmitted to the server 3 via the communication part 9 (step S14).

When there are a plurality of connections between the client 2 and the server 3, there is a limit for the number of connections that can be used for one server 3. For example, it is recommended that HTTP/1.0 and HTTP/1.1 use connections (sessions) of up to four and two, respectively.

Response delay can be minimized by containing as many requests as possible in the initial packet of each connection. For example, if there are four connections, there are four packets of a data length L, each data being transmitted without being divided. It is a feature of the present embodiment that as many information acquisition requests as possible are packed in these four packets.

One example of the way to pack information acquisition requests is, as shown in FIG. 4, to pack information acquisition requests in a packet in order beginning from the header information acquisition request. In the example of FIG. 4, information acquisition requests are packed in packets in the following way. Three information acquisition requests beginning from the header information acquisition request are packed in a packet for a connection A. When this packet exceeds the MTU size, the succeeding two information acquisition requests are packed in a packet for a connection B. When this packet exceeds the MTU size, the succeeding three information acquisition requests are packed in a packet for a connection C. And when this packet exceeds the MTU size, the last two information acquisition requests are packed in a packet for a connection D.

The specific procedure of allocating a plurality of information acquisition requests to a plurality of connections is not limited to any particular one such as shown in FIGS. 3 and 4. Any algorism (for example, linear programming) can be adopted.

As described above, in the first embodiment, a pipeline request in which as many information acquisition requests as possible are packed in one packet is generated and transmitted to the server 3. When the information acquisition requests are packed in one packet, the requests are packed so as not to exceed the information delimiter prescribed by a lower-level protocol. Therefore, a standby time of the server 3 can be shortened, the server 3 can return a response quickly, and the number of responses can be reduced. Accordingly, a standby time can be shortened and power consumption can be reduced for both of the client 2 and the server 3.

### Second Embodiment

A second embodiment which will be explained below is to give a priority order to information acquisition requests to the server 3.

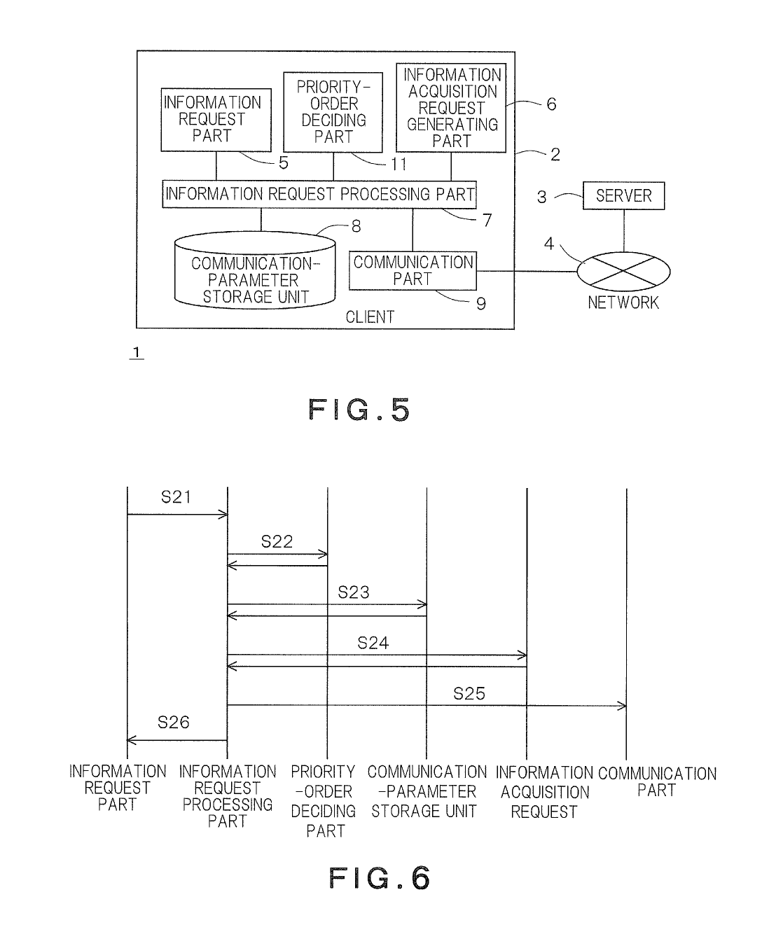

FIG. 5 is a block diagram schematically showing the configuration of an information processing system 1 according to the second embodiment. In FIG. 5, the elements common with FIG. 1 are given the same reference numerals. In the following, different points will be mainly explained.

The client 2 of FIG. 5 has a priority-order deciding part 11 in addition to the configuration of FIG. 1. The priority-order deciding part 11 decides an order of priority of information acquisition requests each generated by the information request part 5. The priority order is decided based on the type of file of requested information, whether requested information is displayed on a display screen, whether requested information has been stored in a file cache, etc. The technique of deciding a priority order is not limited to any particular one.

FIG. 6 is a sequence diagram showing an example of a procedure of the client 2 according to the second embodiment. Step S21 of FIG. 6 is the same as step S1 of FIG. 1. When information acquisition requests from the information request part 5 are transferred to the information request processing part 7 in step S21, the information request processing part 7 inquires the priority-order deciding part 11 about the priority order of the information acquisition requests (step S22). Thereafter, the steps similar to steps S2 to S5 of FIG. 2 are carried out (step S23 to S26).

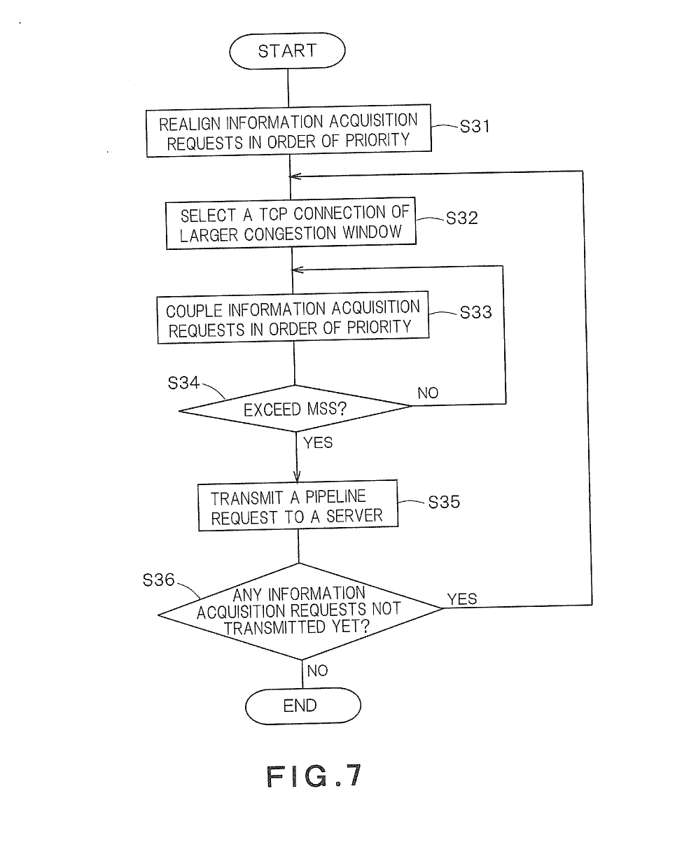

FIG. 7 is a flowchart showing an example of a procedure of the information request processing part 7 according to the second embodiment. Firstly, the priority order of information requested by the information request part 5 is inquired to the priority-order deciding part 11 to realign the information acquisition requests in order of priority (step S31).

Next, a TCP connection in a good communication condition is selected (step S32). Parameters used for determination of a good communication condition are throughput, a delay time, an error rate, the size of a congestion window, the degree of change of any of these factors or of the combination of these factors, etc. Next, the information acquisition requests are coupled in order of priority to the selected TCP connection to generate a pipeline request (step S33). When coupling the information acquisition requests, information acquisition requests of higher priority may be aligned from the header of the pipeline request. The reason for this alignment is that the information acquisition requests are sent to the server 3 in order of priority and it is highly likely that responses from the server 3 are obtained also in order of priority. A connection with a congestion window of larger size that is expected to achieve high throughput may be preferentially used for information acquisition requests of higher priority.

Next, it is determined whether the length of information in the pipeline request exceeds the MTU size of IP that is a lower-level protocol of TCP (step S34). If the length of information in the pipeline request does not exceed the MTU size of IP, a coupling process for the information acquisition requests in step S33 is continued. If the length of information in the pipeline request exceeds the MTU size of IP, a pipeline request for which coupling has been completed is transmitted to the server 3 via the communication part 9 by using the TCP connection selected in step S32 (step S35).

Next, it is determined whether there is an information acquisition request not transmitted yet. If there is an information acquisition request not transmitted yet, the procedure returns to step S32. If there is no information acquisition request not transmitted yet, the procedure ends.

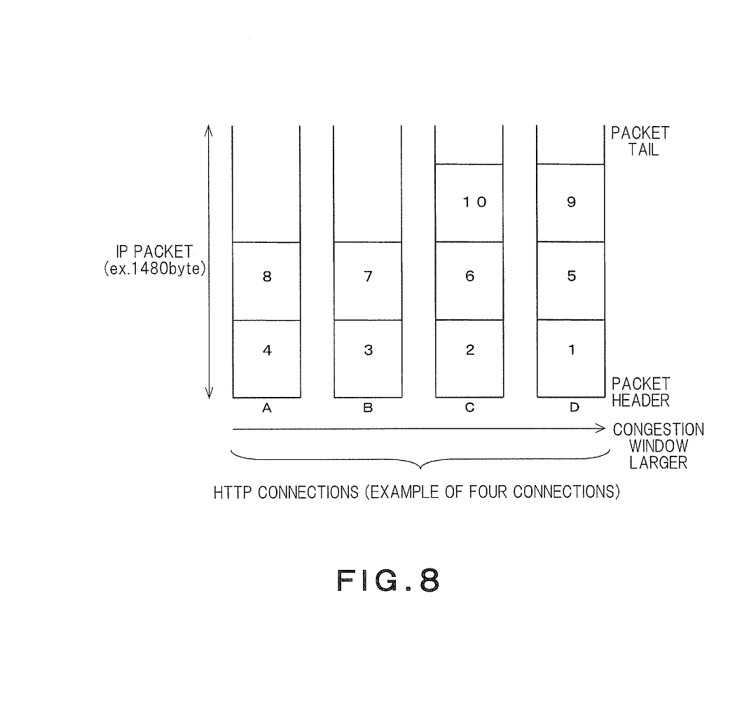

FIG. 8 is a view schematically showing an example of a technique of generating pipeline requests according to the second embodiment. In the example of FIG. 8, there are four connections A to D, with the numbers 1 to 10 being given to information acquisition requests in order of priority. The connections A to D are aligned in order of size of congestion windows from the smallest to the largest. The congestion window of the connection D is the largest.

In the example of FIG. 8, information acquisition requests of higher priority are aligned from the header of a packet for each connection and an information acquisition request of higher priority is transmitted by a connection with a congestion window of larger size.

As described above, in the second embodiment, an order of priority is given to the information acquisition requests and information acquisition requests of higher priority are aligned from the header of a packet. Therefore, it is ensured that a response corresponding to an information acquisition request of higher priority reaches before a response corresponding to an information acquisition request of lower priority. Moreover, information acquisition requests of higher priority are transmitted by actively using a connection with an enlarged congestion window, hence high throughput is expected. Especially, responses to information acquisition requests of higher priority can be acquired quickly.

### Third Embodiment

A third embodiment which will be explained below is to perform deletion, compression or replacement of redundant meta-information of a header. A block diagram of an information processing system 1 according to the third embodiment is similar to that of FIG. 1 or 5, hence the explanation thereof being omitted.

One feature of the present embodiment is to delete, compress or replace duplicate and unessential redundant meta-information contained in a header of a pipeline request generated by the information request processing part 7. Meta-information to be deleted, compressed or replaced may be any information contained in the same pipeline request in which contents is the same, duplicate and redundant meta information, such as user agent information of a browser which does not change while using the HTTP pipelining, the corresponding character information or compression mode.

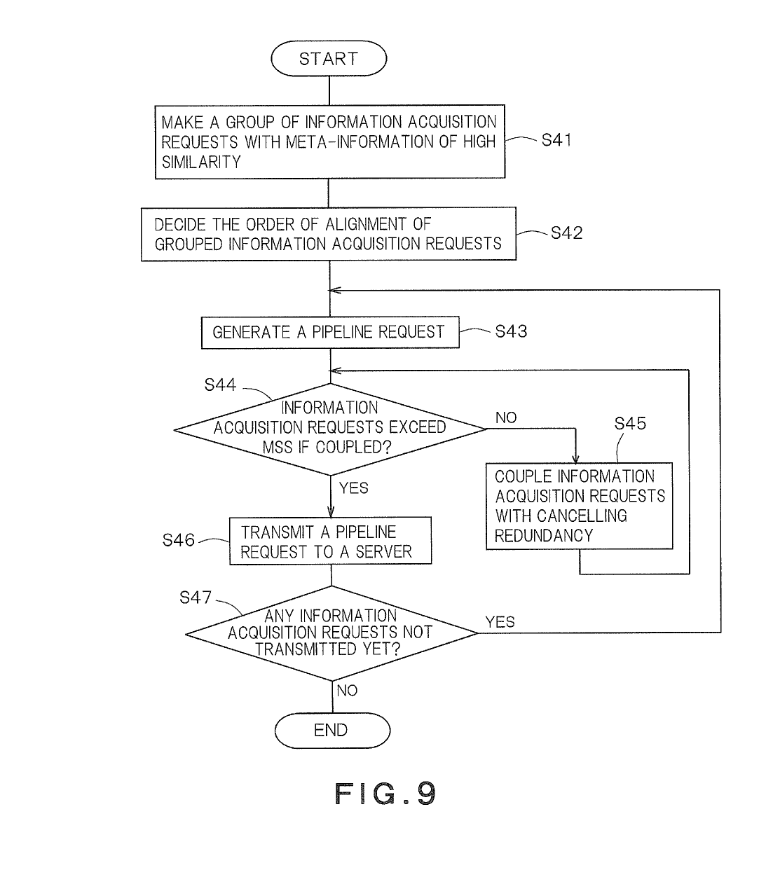

FIG. 9 is a flowchart showing a procedure of the information request processing part 7 according to the third embodiment.

Firstly, information acquisition requests with meta-information of high similarity are put into a group (step S41). Next, the order of alignment of the grouped information acquisition requests is decided (step S42).

Next, in accordance with the order of alignment decided in step S42, information acquisition requests each containing meta-information are concatenated to generate a pipeline request (step S43).

Then, it is determined, if a new information acquisition request containing meta-information is coupled to the generated pipeline request, whether the coupled pipeline request exceeds an information delimiter (for example, a TCP window size, an IP MTU size, a physical-layer frame length, etc.) prescribed by a low-level protocol (step S44). If the coupled pipeline request does not exceed yet, redundant meta-information contained in the generated pipeline request is deleted, compressed or replaced, and then meta-information corresponding to the new information acquisition request is coupled to the generated pipeline request (step S45), and the procedure returns to step S44.

If it is determined in step S44 that the coupled pipeline request exceeds the information delimiter prescribed by the low-level protocol, the generated pipeline request is transmitted to the server 3 via the communication part 9 (step S46).

Then, it is determined whether there is an information acquisition request not transmitted yet (step S47). If there is, the procedure returns to step S43, but if not, the procedure ends.

As described above, in the third embodiment, redundant met-information is deleted, compressed or replaced among meta-information contained in a pipeline request having a plurality of information acquisition requests concatenated. Therefore, the data length of a pipeline request can be reduced and hence more information acquisition requests can be coupled to the pipeline request to the extent of the reduced length, thereby realizing higher-speed communication and reduction of power consumption.

### Fourth Embodiment

A fourth embodiment which will be explained below describes a configuration and an operation of a server 3 that returns a response to a pipeline request sent from the client 2 of the first to third embodiments.

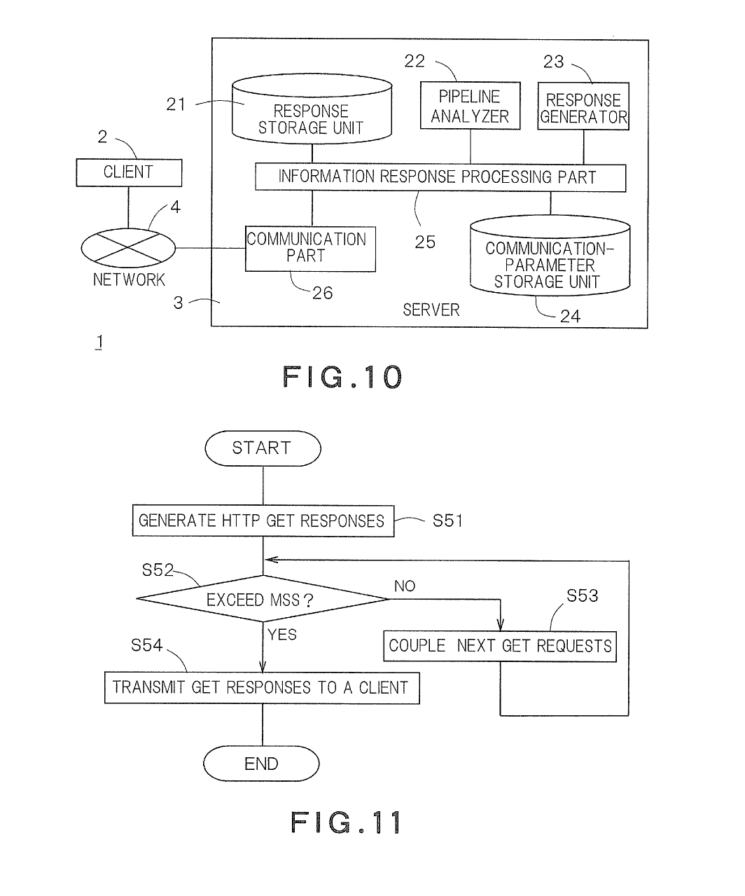

FIG. 10 is a block diagram schematically showing the configuration of an information processing system 1 provided with a server 3 according to the fourth embodiment. The client 2 shown in FIG. 10 is identical with the client 2 of any of the first to third embodiments.

The server 3 of FIG. 10 has a response storage unit 21, a pipeline analyzer 22, a response generator 23, a communication-parameter storage unit 24, an information response processing part 25, and a communication part 26.

The pipeline analyzer 22 analyzes a pipeline request from the client 2 to extract an information acquisition request.

The communication-parameter storage unit 24 stores communication parameters for a communication protocol to be used in communication between the client 2 and the server 3. The communication parameters are, for example, throughput, delay, the degree of change of these factors, a TCP congestion window, a maximum segment length, a maximum packet length, IP MTU, a frame length in the physical layer, etc.

The response generator 23 generates a response in accordance with an information acquisition request contained in a pipeline request. The response is added with meta-information based on communication parameters and stored in the response storage unit 21.

The information response processing part 25 receives a pipeline request transmitted from the client 2 via the communication part 26 and transfers the pipeline request to the pipeline analyzer 22. Moreover, the information response processing part 25 generates a pipeline response having responses stored in the response storage unit 21 pipelined and transfers the pipeline response to the client 2 via the communication part 26.

FIG. 11 is a flowchart showing an example of a procedure of the information response processing part 25 of FIG. 10. At the start of the flowchart, the information response processing part 25 receives a pipeline request transmitted by the client 2 via the communication part 26 and transfers the pipeline request to the pipeline analyzer 22. The pipeline analyzer 22 extracts each information acquisition request contained in the pipeline request and stores a response in accordance with each information acquisition request in the response storage unit 21.

Then, the information response processing part 25 generates an HTTP GET response (step S51). Next, it is determined whether a response or a pipeline response exceeds an information delimiter prescribed by a low-level protocol (step S52). In this determination, for example, it is determined whether a response or a pipeline response exceeds an IP MTU size. If not, the next response is coupled to the HTTP GET response (step S53) and the procedure returns to step S52.

If it is determined that a response or a pipeline response exceeds an IP MTU size in step S52, the GET response is transferred to the client 2 via the communication part 26 (step S54).

As described above, in the fourth embodiment, the server 3 that has received a pipeline request from the client 2 determines whether a pipeline response having the coupled responses, in accordance with respective information acquisition requests exceeds an information delimiter prescribed by a low-level protocol, and returns a pipeline response having the coupled responses within the range not exceeding the information delimiter. Therefore, the number of responses can be kept at minimum, response to the client 2 can be done quickly, and power consumption can be reduced.

### Fifth Embodiment

A fifth embodiment which will be described below provides a proxy apparatus (relay apparatus) between a client 2 and a server 3, which relays communication between the client 2 and the server 3.

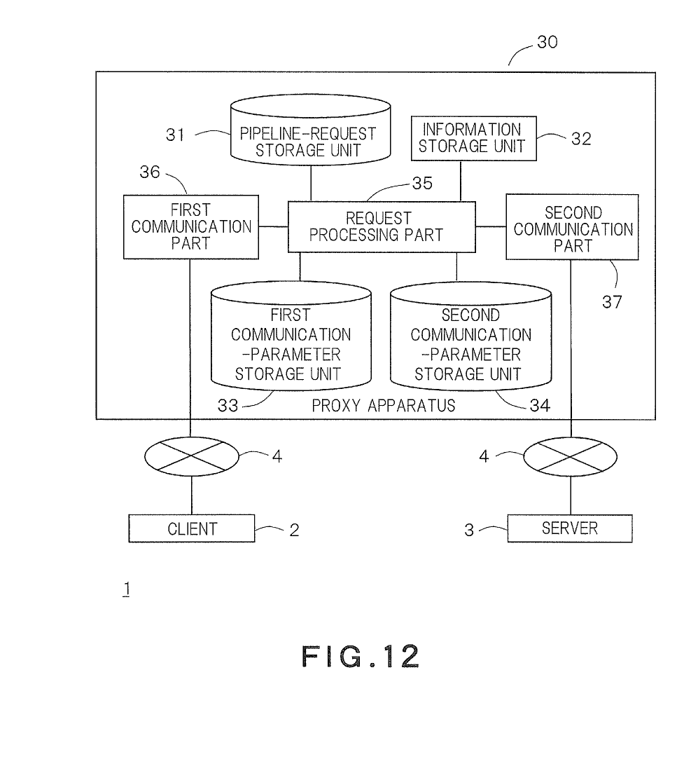

FIG. 12 is a block diagram schematically showing the configuration of an information processing system 1 according to a fifth embodiment. The information processing system 1 of FIG. 12 is provided with a proxy apparatus 30 connected to the network 4.

For example, the proxy apparatus 30 receives a pipeline request or a request transmitted by the client 2 and transmits a new pipeline request or request generated by processing the received pipeline request or request, such as by reconfiguration, to the server 3.

Moreover, the proxy apparatus 30 receives a pipeline response or a response transmitted by the server 3 and transmits a new pipeline response or response generated by processing the received pipeline response or response, such as by reconfiguration, to the client 2.

The proxy apparatus 30 of FIG. 12 has a pipeline-request storage unit 31, an information storage unit 32, a first communication-parameter storage unit 33, a second communication-parameter storage unit 34, a request processing part 35, a first communication part 36, and a second communication part 37.

The request storage unit 31 temporarily stores a request or a pipeline request sent from the client 2. The information storage unit 32 temporarily stores a response or a pipeline response received from the server 3.

The communication-parameter storage unit 33 stores communication parameters concerning a communication protocol to be used in communication with the client 2. The second communication-parameter storage unit 34 stores communication parameters concerning a communication protocol to be used in communication with the server 3.

Communication parameters to be stored by the first and second communication-parameter storage units 33 and 34 are, like the communication parameters explained in the first to fourth embodiments, throughput, delay, an error rate, the degree of change of these factors, a TCP congestion window, a maximum segment length, a maximum packet length, IP MTU, a frame length in the physical layer, etc.

The request processing part 35 reconfigures a pipeline request transmitted from the client 2 to generate a new pipeline request or non-pipelined requests. The request processing part 35 may transmit a pipeline request transmitted from the client 2 to the server 3, without reconfiguration.

Moreover, the request processing part 35 reconfigures a pipeline response transmitted from the server 3 to generate a new pipeline response or responses, or transmits a pipeline response transmitted from the server 3 to the server 3, without reconfiguration.

The first communication part 36 communicates with the client 2 via the network 4. The second communication part 37 communicates with the server 3 via the network 4.

The client 2 and the server 3 of FIG. 12 may be identical with the client 2 explained in any of the first to third embodiment and the server 3 explained in the fourth embodiment, respectively. Or only the client 2 of FIG. 12 may be identical with the client 2 explained in any of the first to third embodiment. Or only the server 3 of FIG. 12 may be identical with the server 3 explained in the fourth embodiment.

The following three ways are considered to be the procedure of transmitting a pipeline request from the client 2 to the proxy apparatus 30.

1. The client 2 transmits a pipeline request to the proxy apparatus 30. The proxy apparatus 30 receives the pipeline request by using the first communication part 36. The proxy apparatus 30 converts the pipeline request into non-pipelined requests and transmits the non-pipelined requests to the server 3 from the second communication part 37 by using many connections.

2. The client 2 transmits non-pipelined requests to the proxy apparatus 30. The proxy apparatus 30 receives the non-pipelined requests by using the first communication part 36. The proxy apparatus 30 converts the non-pipelined requests into a pipeline request and transmits the pipeline request to the server 3 by using the second communication part 37.

3. The client 2 transmits a pipeline request to the proxy apparatus 30. The proxy apparatus 30 receives the pipeline request by using the first communication part 36. The proxy apparatus 30 transmits the pipeline request to the server 3 by using the second communication part 37.

The following three ways are considered to be the procedure of transmitting a pipeline response from the server 3 to the proxy apparatus 30.

4. The server 3 transmits a pipeline response to the proxy apparatus 30. The proxy apparatus 30 receives the pipeline response by using the second communication part 37. The proxy apparatus 30 analyzes the pipeline response and transmits non-pipelined responses to the client 2 by using the first communication part 36.

5. The server 3 transmits non-pipelined responses to the proxy apparatus 30. The proxy apparatus 30 receives the non-pipelined responses by using the second communication part 37. The proxy apparatus 30 generates a pipeline response having responses in accordance with the order of requests sent from the client 2 and stored in the pipeline-request storage unit 31, and transmits the pipeline response to the client 2 by using the first communication part 36.

6. The server 3 transmits a pipeline response to the proxy apparatus 30. The proxy apparatus 30 receives the pipeline response by using the second communication part 37. The proxy apparatus 30 transmits the pipeline response to the client 2 by using the first communication part 36.

When a pipeline request is generated, as described in the second embodiment, based on the order of priority of information acquisition requests, the information acquisition requests are transmitted to the server 3 by the following procedure.

Firstly, the request processing part 35 in the proxy apparatus 30 stores a pipeline request received from the client 2 in the pipeline-request storage unit 31 for a certain period. Then, the request processing part 35 selects information acquisition requests in order of priority from among a plurality of information acquisition requests contained in the pipeline request stored in the pipeline-request storage unit 31 to generate a pipeline request having information acquisition requests of higher priority aligned at the header of the pipeline. The priority order is determined by file types or the like, like the second embodiment.

Next, the request processing part 35 transmits the generated pipeline request to the server 3.

The request processing part 35 stores responses transmitted from the sever 3 one by one in response to the pipeline request in the information storage unit 32 and makes one-to-one correspondence between the stored responses and original information acquisition requests that have been stored in the pipeline-request storage unit 31 so as not make a mistake on the order of transmission to generate a pipeline response in which as many responses as possible are concatenated. Then, the request processing part 35 transmits the generated pipeline response to the client 2.

As described above, in the fifth embodiment, a pipeline request transmitted from the client 2 is received by the proxy apparatus 30 instead of the server 3, and the pipeline request is reconfigured according to need and transmitted to the server 3. Or a pipeline request transmitted from the server 3 is received by the proxy apparatus 30 instead of the client 2, and the pipeline request is reconfigured according to need and transmitted to the client 2. In either case, the client 2 or the server 3 can reduce the number of times of transmission of requests or responses, thus realizing low power consumption.

At least one of the client 2, the server 3 and the proxy apparatus 30 explained in the above embodiments may be configured with hardware or software. When configuring with software, a program that realizes the function of at least one of the client 2, the server 3 and the proxy apparatus 30 may be stored in a storage medium such as a flexible disk and CD-ROM, and installed in a computer to be executed. Not being limited to a detachable type such as a magnetic disk and an optical disk, the storage medium may be a stationary type such as a hard disk and a memory.

Moreover, a program that realizes the function of at least one of the client 2, the server 3 and the proxy apparatus 30 may be distributed via a communication network (including wireless communication) such as the Internet. The program may also be distributed via an online network such as the

Internet or a wireless network, or stored in a storage medium and distributed under the condition that the program is encrypted, modulated or compressed.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A communication apparatus, comprising:
a communication part configured to communicate with a different communication apparatus;
an information request part configured to generate information requests to the different communication apparatus;
an information acquisition request generating part configured to generate information acquisition requests each comprising meta-information added to each of the information requests generated by the information request part; and
an information request processing part configured to generate a pipeline request in which as many of the information acquisition requests as possible are concatenated within a length which does not exceed an information delimiter prescribed by a low-level protocol of a level lower than a protocol used to transmit the pipeline request to the different communication apparatus via the communication part.

2. The communication apparatus of claim 1, wherein the information request processing part generates the pipeline request in which as many of the information acquisition requests as possible are concatenated so that information is not fragmented in a communication path to the different communication apparatus.

3. The communication apparatus of claim 1, wherein the information request processing part generates the pipeline request in which as many of the information acquisition requests as possible are concatenated within a range of a maximum data length capable of being transmitted at one time, the maximum data length being prescribed by the low-level protocol.

4. The communication apparatus of claim 1, wherein the information request processing part deletes, compresses or replaces redundant meta-information contained in the pipeline request.

5. The communication apparatus of claim 1, further comprising a priority-order deciding part configured to decide an order of priority of information acquisition requests each generated by the information request part,
wherein the information request processing part generates the pipeline request in which the information acquisition requests are aligned in order of priority decided by the priority-order deciding part.

6. The communication apparatus of claim 5, wherein the information request processing part aligns the information acquisition requests of higher priority at a header side of the pipeline request.

7. The communication apparatus of claim 5, wherein the information request processing part transmits the pipeline request comprising the information acquisition requests of higher priority by using a connection having a wide congestion window.

8. The communication apparatus of claim 5, wherein the priority-order deciding part decides the order of priority based on at least one of a file type of information requested to the different communication apparatus, whether the information is displayed on a display screen, a display position of the information, a distance from the displayed information on the display screen, whether the information is held as a file cache, and whether the information decides a screen layout.

9. A communication apparatus, comprising:
a communication part configured to communicate with a different communication apparatus;
a pipeline analyzer configured to analyze a plurality of information acquisition requests concatenated and contained in a pipeline request which is transmitted from the different communication apparatus;
a response generator configured to generate responses in accordance with the information acquisition requests contained in the pipeline request; and
an information response processing part configured to generate a pipeline response in which as many of the responses as possible are concatenated within a range of not exceeding an information delimiter prescribed by a low-level protocol of a level lower than a protocol to be used for returning responses in accordance with the information acquisition requests and to transmit the pipeline response to the different communication apparatus via the communication part.

10. A relay apparatus which relays communication between the communication apparatus of claim 1 and the different communication apparatus, comprising:
a first communication part configured to communicate with the communication apparatus and receive the request or the pipeline request transmitted from the communication apparatus; and
a second communication part configured to communicate with the different communication apparatus and transmit a new request or pipeline request generated by reconfiguring the request or the pipeline request transmitted from the communication apparatus, to the different communication apparatus.

11. The relay apparatus of claim 10, wherein:
the pipeline request is received by the first communication part from the communication apparatus by using a minimum necessary connection;
the pipeline request is converted into a plurality of requests; and
the requests are transmitted from the second communication part by using a plurality of connections.

12. The relay apparatus of claim 10, wherein:
a plurality of requests are received from the communication apparatus by the first communication part by using a plurality of connections;
a pipeline request is generated based on the plurality of requests; and
the pipeline request is transmitted from the second communication part to the different communication apparatus by using a minimum necessary connection.

13. A communication method, comprising:
generating information acquisition requests to be sent from a communication apparatus to a different communication apparatus;
generating information acquisition requests each comprising meta-information added to each of the generated information acquisition requests; and
generating a pipeline request in which as many of the information acquisition requests as possible are concatenated within a range which does not exceed an information delimiter prescribed by a low-level protocol of a level lower than a protocol to be used to transmit the information acquisition requests to the different communication apparatus, to transmit the pipeline request to the different communication apparatus via a communication part.

14. The communication method of claim 13, further comprising:
analyzing a plurality of information acquisition requests concatenated and contained in the pipeline request which is transmitted from the communication apparatus;
generating responses in accordance with the information acquisition requests contained in the pipeline request; and
generating a pipeline response in which as many of the responses as possible are concatenated within a range of not exceeding an information delimiter prescribed by a low-level protocol of a level lower than a protocol used to return responses in accordance with the information acquisition requests and to transmit the pipeline response to the communication apparatus via the communication part.

15. The communication method of claim 13, wherein the pipeline request is generated in which as many of the information acquisition requests as possible are concatenated so that information is not fragmented in a communication path to the different communication apparatus.

16. The communication method of claim 13, wherein the pipeline request is generated in which as many of the information acquisition requests as possible are concatenated within a range of a maximum data length capable of being transmitted at one time, the maximum data length being prescribed by the low-level protocol.

17. The communication method of claim 13, wherein redundant meta-information contained in the pipeline request is deleted, compressed or replaced.

18. The communication method of claim 13, wherein:
An order of priority is decided for the generated information requests; and
the pipeline request is generated in which the information acquisition requests are aligned in order of priority in accordance with the decided order.

19. The communication method of claim 18, wherein the information acquisition requests of higher priority are aligned at a head side of the pipeline request.

20. The communication method of claim 18, wherein the pipeline request comprising the information acquisition requests of higher priority is transmitted by using a connection having a wide congestion window.
